(19) United States
(12) Patent Application Publication
(10) Pub. No.: US 2024/0361622 A1
(43) Pub. Date: Oct. 31, 2024

(54) OPTICAL MODULATOR

(71) Applicant: Murata Manufacturing Co., Ltd., Nagaokakyo-shi (JP)

(72) Inventors: Satoki HAMAMURA, Nagaokakyo-shi (JP); Yasuhiro AIDA, Nagaokakyo-shi (JP)

(21) Appl. No.: 18/765,418

(22) Filed: Jul. 8, 2024

Related U.S. Application Data
(63) Continuation of application No. PCT/JP2022/043689, filed on Nov. 28, 2022.

(30) Foreign Application Priority Data
Mar. 17, 2022 (JP) 2022-042073

(51) Int. Cl. G02F 1/03; G02F 1/035; G02F 1/21

(52) U.S. Cl. CPC G02F 1/0316; G02F 1/035; G02F 1/212; G02F 2202/20

(57) ABSTRACT

An optical modulator includes an optical waveguide, a first electrode, a second electrode, and a low dielectric constant layer. The optical waveguide is made of a material having an electro-optic effect. The first and second electrodes generate a potential difference with each other. In a cross-sectional view in a direction perpendicular or substantially perpendicular to an extending direction of the optical waveguide, the first electrode is on first side of the optical waveguide in a width direction and on first side of the optical waveguide in a thickness direction, the second electrode is on the second side of the optical waveguide in the width direction and on the second side of the optical waveguide in the thickness direction, the low dielectric constant layer is interposed between the first electrode and the optical waveguide, and a portion of the first electrode adjacent to the optical waveguide is in the low dielectric constant layer.

### CROSS REFERENCE TO RELATED APPLICATIONS

This application claims the benefit of priority to Japanese Patent Application No. 2022-042073 filed on Mar. 17, 2022 and is a Continuation Application of PCT Application No. PCT/JP2022/043689 filed on Nov. 28, 2022. The entire contents of each application are hereby incorporated herein by reference.

### BACKGROUND OF THE INVENTION

### 1. Field of the Invention

The present disclosure relates to an optical modulator.

### 2. Description of the Related Art

With the widespread use of mobile terminals and cloud computing, Internet traffic is increasing significantly. For this reason, demand for optical communication is expanding. In optical communication, an optical transceiver is required for interconversion of optical signals and electrical signals. An optical transceiver includes an optical modulator as a main component. An optical modulator has a function of converting electrical signals into optical signals.

An optical modulator of the related art is disclosed, for example, in Japanese Unexamined Patent Application Publication No. 2008-250080. The optical modulator of Japanese Unexamined Patent Application Publication No. 2008-250080 has a thin plate having an electro-optic effect, an optical waveguide formed on the thin plate, and a control electrode to control light passing through the optical waveguide. The control electrode includes a first electrode and a second electrode, the first electrode and the second electrode being arranged so as to sandwich the thin plate. The first electrode has at least a coplanar electrode including a signal electrode and a ground electrode. The second electrode has at least a ground electrode. Below the thin plate, a low refractive index layer having a width at least greater than the width of the signal electrode of the first electrode is formed. A buffer layer is formed at least between the thin plate and the first electrode in some cases.

### SUMMARY OF THE INVENTION

In the optical modulator of Japanese Unexamined Patent Application Publication No. 2008-250080, in a cross section perpendicular or substantially perpendicular to the extending direction of the optical waveguide, the signal electrode of the first electrode has a rectangular or substantially rectangular shape and the signal electrode is aligned with the optical waveguide in the thickness direction of the optical waveguide. In this case, since the entire bottom surface of the signal electrode faces the optical waveguide, light leaking from the optical waveguide tends to be absorbed by the signal electrode, which causes optical loss. Additionally, in the optical modulator of Japanese Unexamined Patent Application Publication No. 2008-250080, a buffer layer is formed between the first electrode including the signal electrode and the thin plate. The buffer layer contributes to adjustment of the effective refractive index. When there is no buffer layer, the difference between the effective refractive index experienced by the electrical signal and the effective refractive index experienced by the light wave is not reduced, and the modulation frequency cannot be increased.

Example embodiments of the present invention provide optical modulators that each reduce or prevent optical loss and increase the modulation frequency.

An optical modulator according to an example embodiment of the present disclosure includes an optical waveguide made of a material having an electro-optic effect, a control electrode to control light passing through the optical waveguide, and a low dielectric constant layer with a dielectric constant lower than a dielectric constant of the optical waveguide, in which the control electrode includes a first electrode and a second electrode that generate a potential difference with each other, and in a cross-sectional view in a direction perpendicular or substantially perpendicular to an extending direction of the optical waveguide: the first electrode is on first side of the optical waveguide in a width direction and on the first side of the optical waveguide in a thickness direction, the second electrode is on a second side of the optical waveguide in the width direction and on the second side of the optical waveguide in the thickness direction, the low dielectric constant layer is interposed between the first electrode and the optical waveguide, and a portion of the first electrode adjacent to the optical waveguide is in the low dielectric constant layer.

According to the optical modulators of example embodiments of the present disclosure, optical loss can be reduced or prevented and the modulation frequency can be increased.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic diagram illustrating a cross section of an optical modulator according to a first example embodiment of the present invention.

FIG. 2 is a schematic diagram for describing properties of a substrate of the optical modulator according to the first example embodiment of the present invention.

FIG. 3 is a schematic diagram illustrating a cross section of an optical modulator according to a second example embodiment of the present invention.

FIG. 4 is a schematic diagram illustrating a cross section of an optical modulator according to a third example embodiment of the present invention.

FIG. 5 is a schematic diagram illustrating a cross section of an optical modulator according to a fourth example embodiment of the present invention.

FIG. 6 is a schematic diagram illustrating a cross section of an optical modulator according to a fifth example embodiment of the present invention.

FIG. 7 is a schematic diagram illustrating a cross section of an optical modulator according to a sixth example embodiment of the present invention.

FIG. 8 is a schematic diagram illustrating a cross section of an optical modulator according to a seventh example embodiment of the present invention.

FIG. 9 is a schematic diagram illustrating a cross section of an optical modulator according to an eighth example embodiment of the present invention.

FIG. 10 is a schematic diagram illustrating a cross section of an optical modulator according to a ninth example embodiment of the present invention.

FIG. 11 is a schematic diagram illustrating a cross section of an optical modulator according to a 10th example embodiment of the present invention.

FIG. 12 is a schematic diagram illustrating a cross section of an optical modulator according to an 11th example embodiment of the present invention.

FIG. 13A is a schematic diagram illustrating the electric field intensity when a first electrode and a second electrode are not stretched.

FIG. 13B is a schematic diagram illustrating the electric field intensity when only the first electrode is stretched.

FIG. 13C is a schematic diagram illustrating the electric field intensity when both the first electrode and the second electrode are stretched.

### DETAILED DESCRIPTION OF THE EXAMPLE EMBODIMENTS

Hereinafter, example embodiments of the present disclosure will be described. Note that while example embodiments of the present disclosure will be described by use of examples in the following description, the present disclosure is not limited to the examples described below. While specific numeric values or specific materials may be exemplified in the following description, the present disclosure is not limited to these examples.

An optical modulator according to the present example embodiment includes an optical waveguide made of a material with an electro-optic effect, a control electrode to control light passing through the optical waveguide, and a low dielectric constant layer with a dielectric constant lower than a dielectric constant of the optical waveguide. The control electrode includes a first electrode and a second electrode that generate a potential difference with each other. In a cross-sectional view in a direction perpendicular or substantially perpendicular to an extending direction of the optical waveguide, the first electrode is on one side of the optical waveguide in a width direction and on one side of the optical waveguide in a thickness direction, and the second electrode is on the other side of the optical waveguide in the width direction and on the other side of the optical waveguide in the thickness direction. In this cross-sectional view, the low dielectric constant layer is interposed between the first electrode and the optical waveguide, and a portion of the first electrode close to the optical waveguide is buried in the low dielectric constant layer (first configuration).

In the optical modulator of the first configuration, from the optical waveguide, the first electrode is shifted to one of both sides in the width direction of the optical waveguide and the second electrode is shifted to the other of both sides in the width direction of the optical waveguide. Moreover, from the optical waveguide, the first electrode is shifted to one of both sides in the thickness direction of the optical waveguide and the second electrode is shifted to the other of both sides in the thickness direction of the optical waveguide. That is, the first electrode, the optical waveguide, and the second electrode are positioned in this order in a direction oblique to the width direction and thickness direction of the optical waveguide. Furthermore, the low dielectric constant layer is interposed between the first electrode and the optical waveguide, and a portion of the first electrode close to the optical waveguide is buried in the low dielectric constant layer. The first electrode is not in contact with the optical waveguide.

Since the positions of the first electrode and the second electrode are shifted in the thickness direction and the width direction from the optical waveguide, the area of the first electrode and the second electrode facing the optical waveguide is smaller than the case where the rectangular electrode is aligned with the optical waveguide in the thickness direction or the width direction of the optical waveguide and the entire surface of the electrode faces the optical waveguide. As a result, light leaking from the optical waveguide is less likely to be absorbed by the first electrode and the second electrode. Accordingly, optical loss can be reduced or prevented.

Furthermore, the electric field from the first electrode to the optical waveguide passes through the low dielectric constant layer. As a result, the effective refractive index experienced by the electrical signal is reduced. At this time, since at least a portion of the first electrode close to the optical waveguide is buried in the low dielectric constant layer, the contact area of the first electrode with the low dielectric constant layer is larger than a case where the first electrode is simply placed on the low dielectric constant layer, and the electric field passing through the low dielectric constant layer increases. Hence, the effective refractive index experienced by the electrical signal can be made smaller than usual. In general, the effective refractive index experienced by the electrical signal is greater than the effective refractive index experienced by the light wave. Then, the difference between the effective refractive index experienced by the electrical signal and the effective refractive index experienced by the light wave is reduced. Accordingly, the modulation frequency can be increased.

In the optical modulator of the first configuration, the first electrode may include a corner portion. This corner portion is arranged on an optical waveguide side and buried in the low dielectric constant layer (second configuration). In this case, since the electric field is concentrated at the corner portion of the first electrode, the intensity of the electric field from the first electrode to the optical waveguide can be increased. Therefore, it is possible to reduce or prevent a reduction in the electric field applied to the optical waveguide between the first electrode and the second electrode.

The optical modulator of the first configuration or the second configuration includes, for example, the following configuration. In a cross-sectional view in a direction perpendicular or substantially perpendicular to the extending direction of the optical waveguide, the optical waveguide includes a first edge extending in the width direction and a second edge parallel or substantially parallel to the first edge and extending in the width direction. In this cross-sectional view, the first electrode is provided on a first edge side (third configuration).

The optical modulator of the first configuration or the second configuration may include the following configuration. In a cross-sectional view in a direction perpendicular or substantially perpendicular to the extending direction of the optical waveguide, the optical waveguide has a semi-elliptical shape including a base as a long axis extending in the width direction. In this cross-sectional view, the first electrode is provided on a base side (fourth configuration).

The above optical modulator may further include the following configuration. In a cross-sectional view in a direction perpendicular or substantially perpendicular to the extending direction of the optical waveguide, the first electrode has a rectangular or substantially rectangular shape, and the first electrode is buried in a surface of the low dielectric constant layer on a side opposite to the optical waveguide (fifth configuration).

The above optical modulator may further include the following configuration. In a cross-sectional view in a direction perpendicular or substantially perpendicular to the extending direction of the optical waveguide, the first electrode is provided only on the one side of a center of the optical waveguide in the thickness direction, and the second electrode is provided only on the other side of the center of the optical waveguide in the thickness direction (sixth configuration).

The above optical modulator preferably includes the following configuration. An auxiliary low dielectric constant layer is provided between the second electrode and the optical waveguide. The auxiliary low dielectric constant layer has a dielectric constant lower than a dielectric constant of the optical waveguide (seventh configuration).

In the optical modulator of the seventh configuration, since the auxiliary low dielectric constant layer is provided between the second electrode and the optical waveguide, the electric field also passes through the auxiliary low dielectric constant layer. As a result, the effective refractive index experienced by the electrical signal is reduced even more. Hence, the difference between the effective refractive index experienced by the electrical signal and the effective refractive index experienced by the light wave is reduced even more. Accordingly, the modulation frequency can be increased even more.

The above optical modulator preferably includes the following configuration. The material of the optical waveguide is LiNbO₃ (eighth configuration). LiNbO₃ (lithium niobate) has a particularly high electro-optic effect. In the present specification, LiNbO₃ is sometimes referred to as LN. The material of the optical waveguide is not particularly limited as long as it has an electro-optic effect. Examples of the material of the optical waveguide may include LiTaO₃ (lithium tantalate), PLZT (lead lanthanum zirconate titanate), KTN (potassium tantalate niobate), and BaTiO₃ (barium titanate).

The above optical modulator preferably includes the following configuration. Of the first electrode and the second electrode, one extends from the optical waveguide in the thickness direction and the other extends from the optical waveguide in the width direction (ninth configuration). In this case, the intensity of the electric field to the optical waveguide increases.

The above optical modulator may further include a substrate provided with the optical waveguide (10th configuration).

The optical modulator of the 10th configuration may include the following configuration. The substrate is made of the same material as the optical waveguide, and the optical waveguide is ridge shaped or substantially ridge shaped (11th configuration) In this case, it is possible to cover the periphery of the optical waveguide except the boundary with the substrate with the low dielectric constant layer. Hence, it is easy to adjust the effective refractive index. Furthermore, it is possible to confine more light in the optical waveguide.

Note, however, that the optical waveguide can also be formed by diffusing titanium (Ti) in the substrate. The optical waveguide can also be formed by a proton exchange method.

The optical modulator of any one of the first to ninth configurations may include two optical modulator units arranged in parallel or substantially parallel with each other. The two optical modulator units each include the optical waveguide, the control electrode, and the low dielectric constant layer (12th configuration).

The optical modulator of the 12th configuration defines a Mach-Zehnder type optical modulator. In this case, intensity modulation is also possible together with phase modulation. As a result, multi-level modulation can be performed and transmission capacity can be increased. Also, the optical modulator of the 12th configuration achieves the same advantageous effects as the first to ninth configurations.

The optical modulator of the 12th configuration may include the following configuration. Of the two optical modulator units, the first electrode of one optical modulator unit is formed integrally with the first electrode of the other optical modulator unit (13th configuration). In this case, the first electrode of the one optical modulator unit can be shared with the other optical modulator unit.

The optical modulator of the 12th configuration or the 13th configuration may include the following configuration. Each of the optical modulator units further includes a substrate provided with the optical waveguide. Of the two optical modulator units, the substrate of one optical modulator unit is arranged in parallel or substantially parallel with the substrate of the other optical modulator unit (14th configuration).

The optical modulator of the 14th configuration may include the following configuration. In each of the optical modulator units, the substrate is made of the same material as the optical waveguide, and the optical waveguide is ridge shaped or substantially ridge shaped (15th configuration). The optical modulator of the 15th configuration corresponds to the 11th configuration. Hence, as with the 11th configuration, it is easy to adjust the effective refractive index, and further, it is possible to confine more light in the optical waveguide.

The optical modulator of the 14th configuration or the 15th configuration may include the following configuration. Of the two optical modulator units, the substrate of one optical modulator unit is integrated with the substrate of the other optical modulator unit, and the optical waveguide of the one optical modulator unit and the optical waveguide of the other optical modulator unit have mutually reversed directions of spontaneous polarization. The same phase voltage is mutually applied to the first electrode of the one optical modulator unit and the first electrode of the other optical modulator unit (16th configuration).

In the optical modulator of the 16th configuration, the substrate of the one optical modulator unit can be shared with the other optical modulator unit. The optical waveguide of the one optical modulator unit and the optical waveguide of the other optical modulator unit are provided in the shared substrate. Hence, the distance between the optical waveguide of the one optical modulator unit and the optical waveguide of the other optical modulator unit can be shortened. In this case, the width of the entire optical modulator can be reduced.

Hereinafter, example embodiments of the present disclosure will be described with reference to the drawings. In the drawings, the same or equivalent configurations are indicated by the same reference numerals and redundant descriptions are omitted.

### First Example Embodiment

### Configuration of Optical Modulator 100

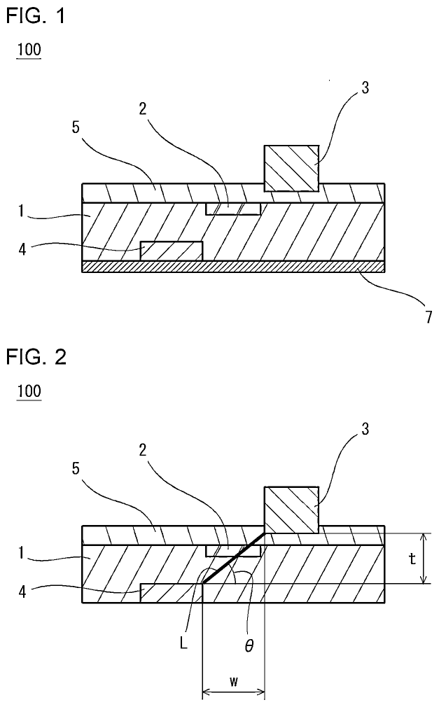

FIG. 1 is a schematic diagram illustrating a cross section of an optical modulator 100 according to a first example embodiment. FIG. 1 illustrates a cross section perpendicular or substantially perpendicular to the extending direction of an optical waveguide 2. The extending direction of the optical waveguide 2 can also be said to be a direction along the optical waveguide 2. In the present specification, unless otherwise specified, a cross section is a cross section perpendicular or substantially perpendicular to the extending direction of the optical waveguide 2 or optical waveguides 2A and 2B described later. In the cross section of the optical modulator 100, a support plate 7 supporting the whole structure is at the bottom, the thickness direction of the optical modulator 100 corresponds to the up-down direction, and the width direction of the optical modulator 100 corresponds to the left-right direction. Note, however, that in the present specification, up, down, left, and right are defined for ease of description and do not limit the actual attitude of the optical modulator 100.

Referring to FIG. 1, the optical modulator 100 includes a substrate 1, the optical waveguide 2, a first electrode 3, a second electrode 4, and a low dielectric constant layer 5. The first electrode 3 and the second electrode 4 are included in a control electrode to control light passing through the optical waveguide 2.

The first electrode 3 and the second electrode 4 generate a potential difference with each other. The first electrode 3 is, for example, a signal electrode. The second electrode 4 is not particularly limited as long as it generates a potential difference with the first electrode 3. The second electrode 4 is, for example, a ground electrode. The second electrode 4 may be a reverse signal electrode that applies a voltage in opposite phase with the potential of the first electrode 3.

The second electrode 4 is located in a lower position than the first electrode 3. The substrate 1, the optical waveguide 2, the low dielectric constant layer 5, the first electrode 3, and the second electrode 4 are supported by the support plate 7. The support plate 7 is located at the bottom.

The optical waveguide 2 is made of a material having an electro-optic effect. The material of the optical waveguide 2 is, for example, LN. The optical waveguide 2 is located in the substrate 1. Specifically, the optical waveguide 2 is located in an upper portion of the substrate 1. The optical waveguide 2 is formed by diffusing Ti in the substrate 1. The portion of the substrate 1 where Ti is diffused has a high refractive index and can confine light, and therefore it can be used as the optical waveguide 2.

The optical waveguide 2 can have, for example, a cross-sectional shape with a width (dimension in left-right direction) larger than thickness (dimension in up-down direction). In FIG. 1, the cross-sectional shape of the optical waveguide 2 is substantially wide and substantially rectangular. In this case, the cross-sectional shape of the optical waveguide 2 includes a first edge extending in the width direction and a second edge parallel or substantially parallel to the first edge and extending in the width direction. The cross-sectional shape of the optical waveguide 2 also includes a third edge and a fourth edge both extending in the thickness direction. In the example illustrated in FIG. 1, the first edge and second edge are a pair of long sides and the third edge and fourth edge are a pair of short sides. In the case where the cross-sectional shape of the optical waveguide 2 is wide and rectangular, one long side (upper first edge) of the pair of long sides is on the surface of the substrate 1, and the other long side (second edge on lower side) is inside the substrate 1.

In the cross section of the optical waveguide 2, the first edge and second edge which are long sides are connected by the third edge and fourth edge which are short sides. In the example illustrated in FIG. 1, the third edge and fourth edge of the optical waveguide 2 are straight lines in a cross-sectional view of the optical modulator 100 and are parallel or substantially parallel to the thickness direction of the optical waveguide 2. Note, however, that the third edge and fourth edge may be inclined with respect to the thickness direction of the optical waveguide 2 and are not necessarily straight lines. In a cross-sectional view of the optical modulator 100, the third edge and fourth edge of the optical waveguide 2 may be curved or may be a combination of straight and curved lines. The length of the third edge may be the same as or different from the length of the fourth edge. Similarly, the length of the first edge may be the same as or different from the length of the second edge.

In some cases, the cross-sectional shape of the optical waveguide 2 is wide and semi-elliptical or substantially wide or substantially semi-elliptical. In this case, the cross-sectional shape of the optical waveguide 2 includes the base as a long axis extending in the width direction and an elliptical arc-shaped side extending in the width direction. In a case where the cross-sectional shape of the optical waveguide 2 is wide and semi-elliptical or substantially semi-elliptical, the base is on the surface of the substrate 1 and the elliptical arc-shaped side is inside the substrate 1.

The low dielectric constant layer 5 is laminated on the substrate 1. Hence, the low dielectric constant layer 5 is laminated on the optical waveguide 2. In this case, the low dielectric constant layer 5 directly covers an upper surface of the optical waveguide 2 and an upper surface of the surrounding substrate 1. For example, in the case where the cross-sectional shape of the optical waveguide 2 is wide and rectangular or substantially rectangular, in the cross section of the optical modulator 100, the low dielectric constant layer 5 is provided mainly along the aforementioned one long side (upper long side) of the optical waveguide 2. In the case where the cross-sectional shape of the optical waveguide 2 is a horizontal semi-elliptical or substantially semi-elliptical shape, in the cross section of the optical modulator 100, the low dielectric constant layer 5 is provided mainly along the aforementioned base of the optical waveguide 2. The dielectric constant of the low dielectric constant layer 5 is lower than the dielectric constant of the optical waveguide 2. The material of the low dielectric constant layer 5 is not particularly limited as long as the dielectric constant thereof is lower than the dielectric constant of the optical waveguide 2. An oxide (e.g., Al₂O₃, SiO₂, LaAlO₃, LaYO₃, ZnO, HfO₂, MgO, or Y₂O₃) is used as the low dielectric constant layer 5. A polymer (e.g., benzo cyclobutene (BCB) or polyimide (PI)) may be used as the low dielectric constant layer 5.

The first electrode 3 is located above the substrate 1. The second electrode 4 is located in a lower portion of the substrate 1. From another perspective, the second electrode 4 is buried in the lower portion of the substrate 1. The first electrode 3 and the second electrode 4 are made of a metal material and each have a rectangular or substantially rectangular cross-sectional shape. For example, in a case where the cross-sectional shape of the optical waveguide 2 is wide and rectangular or substantially wide and substantially rectangular, in the cross section of the optical modulator 100, the first electrode 3 includes a pair of sides parallel or substantially parallel to the aforementioned one long side (upper first edge) of the optical waveguide 2. In a case where the cross-sectional shape of the optical waveguide 2 is wide and semi-elliptical or substantially wide and substantially semi-elliptical, in the cross section of the optical modulator 100, the first electrode 3 has a pair of sides parallel or substantially parallel to the aforementioned base of the optical waveguide 2. The first electrode 3 is buried in a surface of the low dielectric constant layer 5 on a side opposite to the optical waveguide 2. As in the present example embodiment, in a case where a portion of the first electrode 3 is buried in the low dielectric constant layer 5, the thickness (dimension in up-down direction) of the low dielectric constant layer 5 in the portion where the first electrode 3 is located is significantly smaller than the thickness of the low dielectric constant layer 5 in other portions.

The first electrode 3 can be buried in the low dielectric constant layer 5, for example, in the following manner. That is, first, the low dielectric constant layer 5 is formed on the surface of substrate 1 where the optical waveguide 2 is formed. Next, a groove is formed in the low dielectric constant layer 5 by photolithography or etching. Thereafter, the first electrode 3 is formed by performing vapor deposition and lift-off on the groove. As a result, the first electrode 3 buried in the low dielectric constant layer 5 can be formed.

Here, the first electrode 3 and the second electrode 4 sandwich the optical waveguide 2 in a direction oblique to the thickness direction of the optical waveguide 2. The first electrode 3 is provided on one side in the width direction of the optical waveguide 2 and on one side in the thickness direction of the optical waveguide 2. The second electrode 4 is provided on the other side in the width direction of the optical waveguide 2 and on the other side in the thickness direction of the optical waveguide 2. That is, from the optical waveguide 2, the first electrode 3 is shifted to one (to the right in FIG. 1) of both sides in the width direction of the optical waveguide 2 and the second electrode 4 is shifted to the other (to the left in FIG. 1) of both sides in the width direction of the optical waveguide 2. Moreover, from the optical waveguide 2, the first electrode 3 is shifted to one (to the upper side in FIG. 1) of both sides in the thickness direction of the optical waveguide 2 and the second electrode 4 is shifted to the other (to the lower side in FIG. 1) of both sides in the thickness direction of the optical waveguide 2.

The low dielectric constant layer 5 is interposed between the first electrode 3 and the optical waveguide 2. A lower portion of the first electrode 3 is buried in the low dielectric constant layer 5. That is, a portion of the first electrode 3 close to the optical waveguide 2 is buried in the low dielectric constant layer 5. From another perspective, of the first electrode 3, a corner portion arranged on the optical waveguide 2 side is buried in the low dielectric constant layer 5. In this case, the corner portion of the first electrode 3 is near the optical waveguide 2. The first electrode 3 is not in contact with the optical waveguide 2.

In the present example embodiment, in the cross section of the optical modulator 100, the first electrode 3 is provided only on the aforementioned one side of the center of the optical waveguide 2 in the thickness direction, and the second electrode 4 is provided only on the aforementioned other side of the center of the optical waveguide 2 in the thickness direction. For example, in a case where the cross-sectional shape of the optical waveguide 2 is wide and rectangular or substantially wide and substantially rectangular, the entire first electrode 3 is provided on the side of the aforementioned one long side (upper long side) of the center of the optical waveguide 2 in the thickness direction, and the entire second electrode 4 is provided on the side of the aforementioned other long side (lower long side) of the center of the optical waveguide 2 in the thickness direction. In a case where the cross-sectional shape of the optical waveguide 2 is wide and semi-elliptical or substantially wide and substantially semi-elliptical, the entire first electrode 3 is provided on the base side of the center of the optical waveguide 2 in the thickness direction, and the entire second electrode 4 is provided on the side of the aforementioned elliptical arc-shaped side of the center of the optical waveguide 2 in the thickness direction.

In the present example embodiment, when viewed along the left-right direction, the first electrode 3 does not overlap with the optical waveguide 2. Similarly, when viewed along the left-right direction, the second electrode 4 does not overlap with the optical waveguide 2. Additionally, when viewed along the up-down direction, the first electrode 3 does not overlap with the optical waveguide 2. Similarly, when viewed along the up-down direction, the second electrode 4 does not overlap with the optical waveguide 2. The support plate 7 is laminated on the lower side of the substrate 1.

### Effect

According to the optical modulator 100 of the present example embodiment, when the optical modulator 100 is activated, an electric field acts from the first electrode 3 to the second electrode 4, and an electric field is applied to the optical waveguide 2. At this time, in the optical modulator 100 of the present example embodiment, the first electrode 3 and the second electrode 4 sandwich the optical waveguide 2 in a direction oblique to the thickness direction of the optical waveguide 2, and a portion of the first electrode 3 close to the optical waveguide 2 is buried in the low dielectric constant layer 5. Hence, the following effects can be obtained.

In the optical modulator 100 of the present example embodiment, compared to a case where the signal electrode is not buried in the low dielectric constant layer but is simply in contact with the surface of the low dielectric constant layer having a certain thickness, the portion of the first electrode 3 close to the optical waveguide 2, more specifically, the corner portion of the first electrode 3, is buried in the low dielectric constant layer 5 and is near the optical waveguide 2. Since the electric field is concentrated at the corner portion of the first electrode 3, the intensity of the electric field from the first electrode 3 to the optical waveguide 2 increases. Hence, the electric field applied to the optical waveguide 2 is not reduced. Accordingly, it is possible to reduce or prevent a reduction in the electric field applied to the optical waveguide 2.

Moreover, since the low dielectric constant layer 5 is interposed between the first electrode 3 and the optical waveguide 2, the first electrode 3 is not in contact with the optical waveguide 2 but only a portion (corner portion) thereof is near the optical waveguide 2. Hence, compared to a case where an upper surface of an optical waveguide having a rectangular or substantially rectangular cross section is arranged to face a lower surface of a signal electrode having a rectangular or substantially rectangular cross section, even if the minimum separation distance between the optical waveguide 2 and the first electrode 3 is the same, in the optical modulator 100 of the present example embodiment, the region of the first electrode 3 that faces the optical waveguide 2 is small. Therefore, absorption of light leaking from the optical waveguide 2 by the first electrode 3 can be reduced. Accordingly, optical loss can be reduced or prevented.

Furthermore, the electric field from the first electrode 3 to the optical waveguide 2 passes through the low dielectric constant layer 5. As a result, the effective refractive index experienced by the electrical signal is reduced. At this time, since the portion of the first electrode 3 close to the optical waveguide 2, more specifically, the corner portion of the first electrode 3, is buried in the low dielectric constant layer 5, the contact area between the first electrode 3 and the low dielectric constant layer 5 is larger than a case where the electrode is simply placed on the low dielectric constant layer, and the electric field passing through the low dielectric constant layer 5 increases. Hence, the effective refractive index experienced by the electrical signal can be made smaller than usual. In general materials, the effective refractive index experienced by the electrical signal (GHz) is greater than the effective refractive index experienced by the light wave (THz) due to the inclusion of ionic polarization in the optical response. Hence, the difference between the effective refractive index experienced by the electrical signal and the effective refractive index experienced by the light wave is reduced. Accordingly, the modulation frequency can be increased.

### Cut-Angle of Material of Substrate 1

FIG. 2 is a schematic diagram for describing properties of the optical waveguide 2 of the optical modulator 100 according to the first example embodiment. FIG. 2 illustrates a cross section of the optical modulator 100. As illustrated in FIG. 2, the first electrode 3 and the second electrode 4 sandwich the optical waveguide 2 in a direction oblique to the thickness direction of the optical waveguide 2.

When an electric field is applied to the optical waveguide 2 in the substrate 1, the refractive index is changed by the electro-optic effect. At this time, the direction of the electric field can be regarded as parallel or substantially parallel to a line L (see bold line in FIG. 2) connecting the closest corners of the first electrode 3 and the second electrode 4. If the inclination of the crystal axis of the optical waveguide 2 (e.g., c-axis in the case of LN) is parallel or substantially parallel to the direction of the electric field, the refractive index can be varied effectively. The inclination of the electric field, that is, an inclination θ of the electrode arrangement, can be calculated on the basis of the following formula (1) where a component w in the width direction (left-right direction) and a component t in the thickness direction (up-down direction) of the shortest distance between the first electrode 3 and the second electrode 4.

$$θ = arc tan ( t / w ) \times 180 / Π \qquad ( 1 )$$

If the inclination θ of the electrode arrangement is 0 to 5 degrees, for example, a wafer commonly referred to as X-cut may be used as the material of the optical waveguide 2 (substrate 1). If the inclination θ of the electrode arrangement is 85 to 90 degrees, for example, a wafer commonly referred to as Z-cut may be used as the material (substrate 1) of the optical waveguide 2.

### Second Example Embodiment

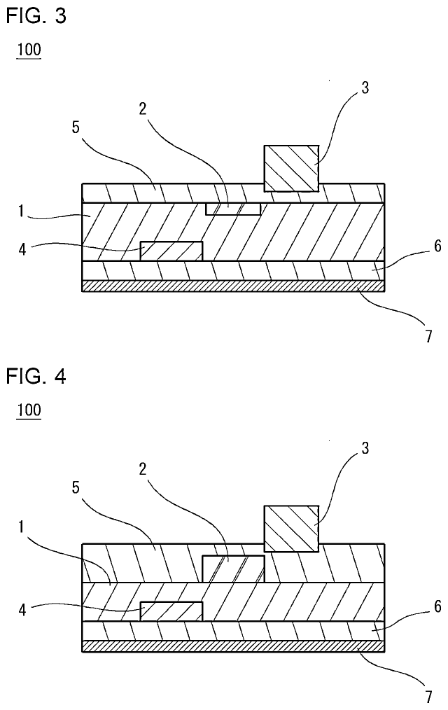

FIG. 3 is a schematic diagram illustrating a cross section of an optical modulator 100 according to a second example embodiment.

The optical modulator 100 of the present example embodiment is a modification of the optical modulator 100 of the first example embodiment.

Referring to FIG. 3, the optical modulator 100 further includes an auxiliary low dielectric constant layer 6. Specifically, the auxiliary low dielectric constant layer 6 is laminated on the lower side of a substrate 1. Similarly to the low dielectric constant layer 5, the dielectric constant of the auxiliary low dielectric constant layer 6 is lower than the dielectric constant of an optical waveguide 2. The material of the auxiliary low dielectric constant layer 6 is not particularly limited as long as the dielectric constant thereof is lower than the dielectric constant of the optical waveguide 2. The material of the auxiliary low dielectric constant layer 6 may be the same as or different from the material of the low dielectric constant layer 5.

In the present example embodiment, a support plate 7 is laminated on the lower side of the auxiliary low dielectric constant layer 6. Furthermore, a second electrode 4 is arranged inside the auxiliary low dielectric constant layer 6. That is, the auxiliary low dielectric constant layer 6 is provided between the second electrode 4 and the optical waveguide 2. In this case, the auxiliary low dielectric constant layer 6 directly covers a lower surface of the substrate 1 and covers a lower surface of the optical waveguide 2.

In the optical modulator 100 of the present example embodiment, since the auxiliary low dielectric constant layer 6 is provided between the second electrode 4 and the optical waveguide 2, the electric field also passes through the auxiliary low dielectric constant layer 6. As a result, the effective refractive index experienced by the electrical signal is reduced even more. Hence, the difference between the effective refractive index experienced by the electrical signal and the effective refractive index experienced by the light wave is reduced even more. Accordingly, the modulation frequency can be increased even more.

### Third Example Embodiment

FIG. 4 is a schematic diagram illustrating a cross section of an optical modulator 100 according to a third example embodiment. The optical modulator 100 of the present example embodiment is a modification of the optical modulator 100 of the first example embodiment.

Referring to FIG. 4, a substrate 1 has a ridge-shaped or substantially ridge-shaped optical waveguide 2. That is, the substrate 1 has a projection in its upper portion, and the projection functions as the optical waveguide 2. The projection is formed on the substrate 1 by processing a material wafer. The projection can confine light in its thickness and width directions. The cross-sectional shape of the ridge-shaped optical waveguide 2 is rectangular or substantially rectangular. To be exact, the cross-sectional shape of the ridge-shaped or substantially ridge-shaped optical waveguide 2 is often trapezoidal or substantially trapezoidal. In the present example embodiment, when viewed along the up-down direction, a first electrode 3 has a slight overlap with the optical waveguide 2. Similarly, when viewed along the up-down direction, a second electrode 4 has a slight overlap with the optical waveguide 2.

The substrate 1 is made of the same material as the optical waveguide 2. Note, however, that the material of the substrate 1 may be different from the material of the optical waveguide 2. In this case, the material of the substrate 1 is, for example, Si.

The optical modulator 100 of the present example embodiment achieves the same advantageous effects as the first example embodiment. However, in the case of the present example embodiment, since the optical waveguide 2 is ridge-shaped, it is possible to cover the periphery of the optical waveguide 2 except the boundary with the substrate 1 with a low dielectric constant layer 5. That is, the low dielectric constant layer 5 covers a large area of the periphery of the optical waveguide 2. Hence, it is easy to adjust the effective refractive index. Furthermore, it is possible to confine more light in the optical waveguide 2.

The configuration of the present example embodiment may be applied to the optical modulator 100 of the second example embodiment.

### Fourth Example Embodiment

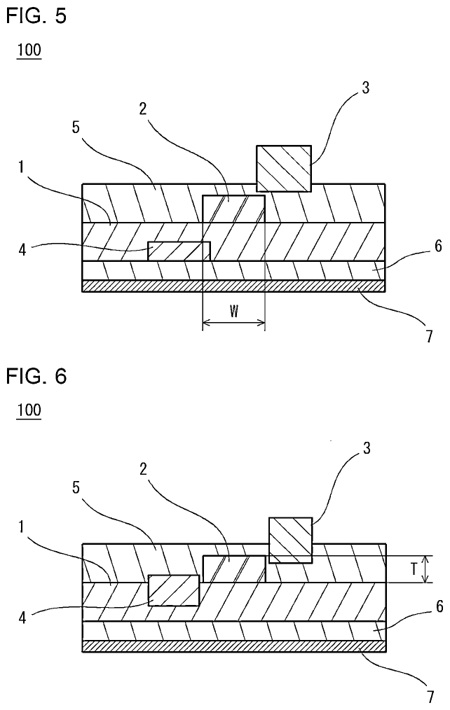

FIG. 5 is a schematic diagram illustrating a cross section of an optical modulator 100 according to a fourth example embodiment. The optical modulator 100 of the present example embodiment is a modification of the optical modulator 100 of the third example embodiment.

Referring to FIG. 5, an optical waveguide 2 is ridge shaped or substantially ridge shaped. In the present example embodiment, when viewed along the up-down direction, a first electrode 3 has an overlap with the optical waveguide 2. In the widthwise region of the optical waveguide 2, the first electrode 3 may overlap within about 10% of the entire width W from the widthwise edge. Similarly, when viewed along the up-down direction, a second electrode 4 has an overlap with the optical waveguide 2. In the widthwise region of the optical waveguide 2, the second electrode 4 may overlap within about 10% of the entire width W from the widthwise edge.

As with the third example embodiment, the optical modulator 100 of the present example embodiment achieves the same advantageous effects as the first example embodiment. However, the configuration of the present example embodiment may be applied to an optical waveguide 2 formed in a substrate 1 by Ti diffusion.

### Fifth Example Embodiment

FIG. 6 is a schematic diagram illustrating a cross section of an optical modulator 100 according to a fifth example embodiment. The optical modulator 100 of the present example embodiment is a modification of the optical modulator 100 of the third example embodiment.

Referring to FIG. 6, an optical waveguide 2 is ridge shaped. In the present example embodiment, when viewed along the up-down direction, a first electrode 3 does not overlap with the optical waveguide 2. Note, however, that when viewed along the left-right direction, the first electrode 3 has an overlap with the optical waveguide 2. In the thickness region of the optical waveguide 2, the first electrode 3 may overlap within about 10% of the entire thickness T from the upper edge. Similarly, when viewed along the up-down direction, a second electrode 4 does not overlap with the optical waveguide 2. Note, however, that when viewed along the left-right direction, the second electrode 4 has an overlap with the optical waveguide 2. In the thickness region of the optical waveguide 2, the second electrode 4 may overlap within about 10% of the entire thickness T from the lower edge.

As with the third example embodiment, the optical modulator 100 of the present example embodiment achieves the same advantageous effects as the first example embodiment. However, the configuration of the present example embodiment may be applied to an optical waveguide 2 formed in a substrate 1 by Ti diffusion.

### Sixth Example Embodiment

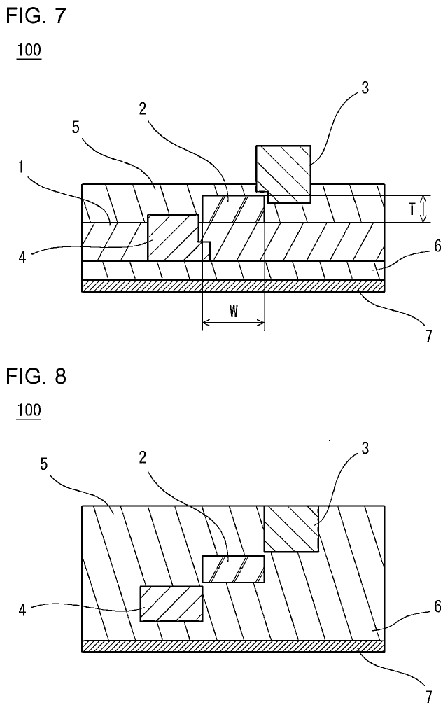

FIG. 7 is a schematic diagram illustrating a cross section of an optical modulator 100 according to a sixth example embodiment. The optical modulator 100 of the present example embodiment is a modification of the optical modulator 100 of the third example embodiment.

Referring to FIG. 7, an optical waveguide 2 is ridge shaped or substantially ridge shaped. In the present example embodiment, when viewed along the up-down direction, a first electrode 3 has an overlap with the optical waveguide 2. Furthermore, when viewed along the left-right direction, the first electrode 3 has an overlap with the optical waveguide 2. In the widthwise region of the optical waveguide 2, the first electrode 3 may overlap within about 10% of the entire width W from the widthwise edge. In the thickness region of the optical waveguide 2, the first electrode 3 may overlap within about 10% of the entire thickness T from the upper edge. As with the first electrode 3, when viewed along the up-down direction, a second electrode 4 has a slight overlap with the optical waveguide 2. Furthermore, when viewed along the left-right direction, the second electrode 4 has an overlap with the optical waveguide 2.

As with the third example embodiment, the optical modulator 100 of the present example embodiment achieves the same advantageous effects as the first example embodiment.

### Seventh Example Embodiment

FIG. 8 is a schematic diagram illustrating a cross section of an optical modulator 100 according to a seventh example embodiment. The optical modulator 100 of the present example embodiment is a modification of the optical modulator 100 of the third example embodiment.

Referring to FIG. 8, in the present example embodiment, a low dielectric constant layer 5 and an auxiliary low dielectric constant layer 6 are integrated into one unit. That is, in a cross-sectional view of the optical modulator 100, the entire periphery of the optical waveguide 2 is covered with the integral low dielectric constant layer 5 and auxiliary low dielectric constant layer 6. This further increases the electric field passing through the low dielectric constant layer 5, and the effective refractive index can be adjusted even more easily.

In the example illustrated in FIG. 8, the entire first electrode 3 is buried in the low dielectric constant layer 5. The first electrode 3 may be partially buried in the low dielectric constant layer 5.

### Eighth Example Embodiment

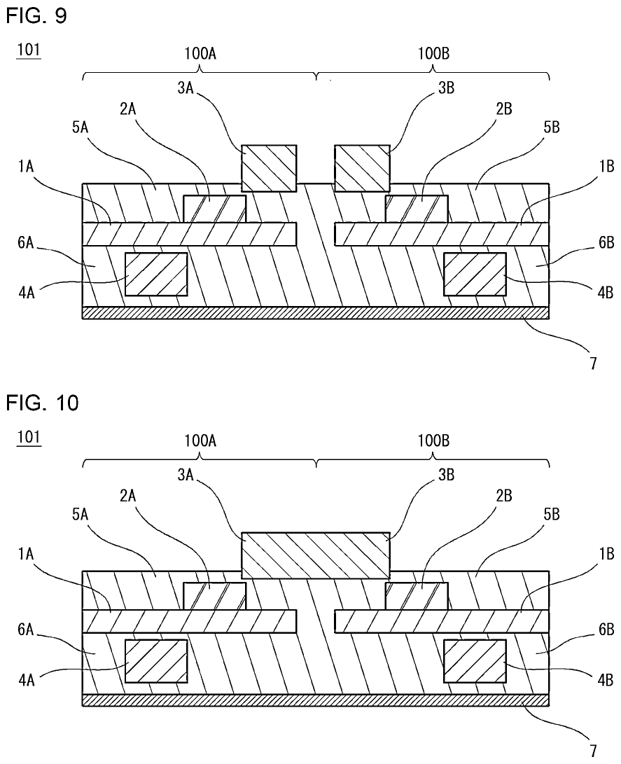

FIG. 9 is a schematic diagram illustrating a cross section of an optical modulator 101 according to an eighth example embodiment. The optical modulator 101 of the present example embodiment defines a Mach-Zehnder type optical modulator. The optical modulator 101 of the present example embodiment is a modification of the optical modulator 100 of the third example embodiment to which the configuration of the second example embodiment is applied, in which elements of the optical modulator 100 of the third example embodiment are arranged in parallel or substantially parallel with each other.

Referring to FIG. 9, the optical modulator 101 of the present example embodiment includes two optical modulator units 100A and 100B.

One optical modulator unit 100A includes a substrate 1A, an optical waveguide 2A, a first electrode 3A, a second electrode 4A, a low dielectric constant layer 5A, and an auxiliary low dielectric constant layer 6A. The other optical modulator unit 100B includes a substrate 1B, an optical waveguide 2B, a first electrode 3B, a second electrode 4B, a low dielectric constant layer 5B, and an auxiliary low dielectric constant layer 6B. The optical modulator units 100A and 100B are supported by a support plate 7.

The substrates 1A and 1B correspond to the aforementioned substrate 1. The optical waveguides 2A and 2B correspond to the aforementioned optical waveguide 2. The low dielectric constant layers 5A and 5B correspond to the aforementioned low dielectric constant layer 5. The first electrodes 3A and 3B correspond to the aforementioned first electrode 3. The second electrodes 4A and 4B correspond to the aforementioned second electrode 4. The auxiliary low dielectric constant layers 6A and 6B correspond to the aforementioned auxiliary low dielectric constant layer 6.

The substrate 1A provided with the optical waveguide 2A is arranged in parallel or substantially parallel with the substrate 1B provided with the optical waveguide 2B. That is, the optical waveguide 2A and the optical waveguide 2B are arranged side by side with each other. The optical waveguides 2A and 2B are both ridge shaped or substantially ridge shaped. Upstream of the optical waveguides 2A and 2B, one incoming optical waveguide branches into the optical waveguides 2A and 2B. Downstream of the optical waveguides 2A and 2B, the optical waveguides 2A and 2B merge into a single outgoing optical waveguide.

As illustrated in FIG. 9, in a cross-sectional view of the optical modulator 101, the optical modulator unit 100A is symmetrical with the optical modulator unit 100B. That is, the optical modulator unit 100A is symmetrical with the optical modulator unit 100B in the width direction. Specifically, in the optical modulator unit 100A, the first electrode 3A is shifted to the optical modulator unit 100B side from the optical waveguide 2A in its width direction, and the second electrode 4A is shifted to the opposite side of the optical modulator unit 100B from the optical waveguide 2A in its width direction. On the other hand, in the optical modulator unit 100B, the first electrode 3B is shifted to the optical modulator unit 100A side from the optical waveguide 2B in its width direction, and the second electrode 4B is shifted to the opposite side of the optical modulator unit 100A from the optical waveguide 2B in its width direction. In this case, the first electrodes 3A and 3B are located closer to each other than the second electrodes 4A and 4B are in the width direction of the optical waveguides 2A and 2B. Note, however, that in a cross-sectional view of the optical modulator 101, the optical modulator unit 100A may be asymmetrical with the optical modulator unit 100B.

The optical modulator 101 of the present example embodiment can also achieve the same advantageous effects as the aforementioned first example embodiment. Furthermore, since the optical modulator 101 of the present example embodiment defines a Mach-Zehnder type optical modulator, intensity modulation is also possible together with phase modulation. As a result, multi-level modulation can be performed and transmission capacity can be increased.

The optical modulator 101 of the present example embodiment may omit the auxiliary low dielectric constant layers 6A and 6B as in the first example embodiment. Alternatively, the optical modulator 101 of the present example embodiment may omit the substrates 1A and 1B as in the seventh example embodiment.

In the optical modulator 101 of the present example embodiment, the optical waveguides 2A and 2B are ridge shaped or substantially ridge shaped. Hence, the same advantageous effects as the third example embodiment can be achieved. Note, however, that the optical waveguides 2A and 2B may be formed by Ti diffusion.

### Ninth Example Embodiment

FIG. 10 is a schematic diagram illustrating a cross section of an optical modulator 101 according to a ninth example embodiment. The optical modulator 101 of the present example embodiment is a modification of the optical modulator 101 of the eighth example embodiment.

Referring to FIG. 10, a first electrode 3A of an optical modulator unit 100A is formed integrally with a first electrode 3B of an optical modulator unit 100B. That is, the first electrode 3B is electrically integrated with the first electrode 3A. In this case, the first electrode 3B can be used also as the first electrode 3A.

### 10th Example Embodiment

FIG. 11 is a schematic diagram illustrating a cross section of an optical modulator 101 according to a 10th example embodiment. The optical modulator 101 of the present example embodiment is a modification of the optical modulator 101 of the ninth example embodiment.

Referring to FIG. 11, a substrate 1A of an optical modulator unit 100A is integrated with a substrate 1B of an optical modulator unit 100B. Optical waveguides 2A and 2B have mutually reversed directions of spontaneous polarization. In a case where the materials of the substrates 1A and 1B are a ferroelectric crystal such as LN or LiTaO₃, the direction of spontaneous polarization can be reversed by applying a high voltage to the ferroelectric crystal material. Reversed polarization can be recognized by atomic force microscopy or electron microscopy. In this case, a first electrode 3B can be used also as a first electrode 3A, and the same phase voltage is applied to the first electrode 3A and the first electrode 3B.

In the optical modulator 101 of the present example embodiment, the distance between the optical waveguides 2A and 2B can be shortened. In this case, the width of the entire optical modulator 101 can be reduced, whereby the optical modulator 101 can be reduced in size.

### 11th Example Embodiment

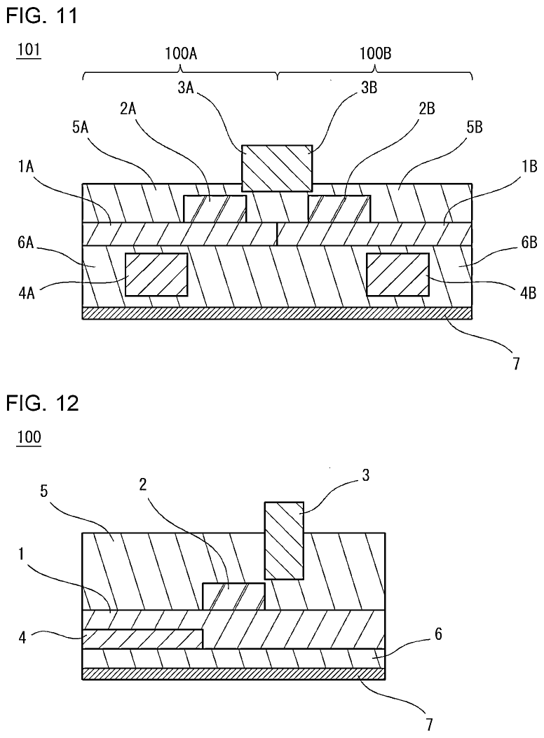

FIG. 12 is a schematic diagram illustrating a cross section of an optical modulator 100 according to an 11th example embodiment. The optical modulator 100 of the present example embodiment is a modification of the optical modulator 100 of the third example embodiment.

Referring to FIG. 12, a first electrode 3 is stretched upward. That is, the first electrode 3 extends from an optical waveguide 2 in the thickness direction. On the other hand, a second electrode 4 is stretched sideward. That is, the second electrode 4 extends from the optical waveguide 2 in the width direction. In this case, the electric field can be applied to a low dielectric constant layer 5 without changing in the intensity of the electric field.

Note, however, that the first electrode 3 may be stretched sideward. That is, the first electrode 3 may extend from the optical waveguide 2 in the width direction. On the other hand, the second electrode 4 may be stretched downward. That is, the second electrode 4 may extend from the optical waveguide 2 in the thickness direction.

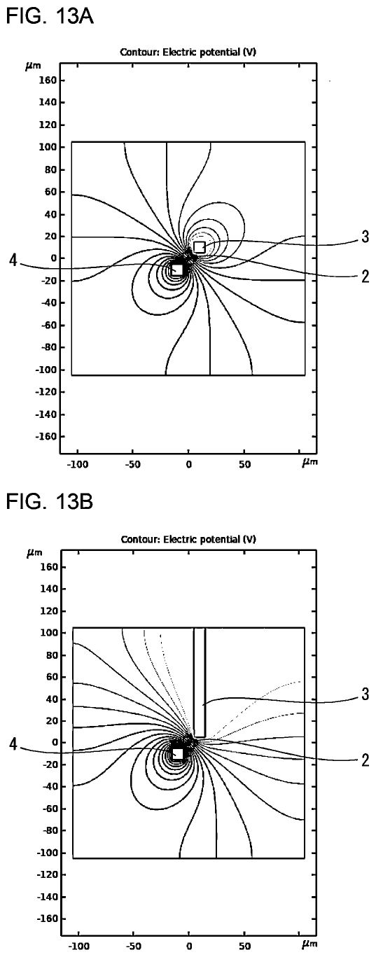

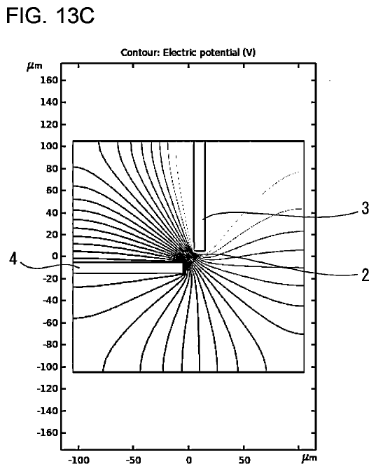

FIGS. 13A to 13C are schematic diagrams illustrating correlations between electrode length and electric field intensity. FIGS. 13A to 13C illustrate cross sections of optical modulators 100. FIG. 13A illustrates a state where the first electrode 3 and the second electrode 4 are not stretched. FIG. 13B illustrates a state where only the first electrode 3 is stretched. FIG. 13C illustrates a state where both the first electrode 3 and the second electrode 4 are stretched. In each drawing, the electrical potential (V) is drawn as contour lines. The narrower the contour interval, the stronger the electric field (V/m). Outside the optical waveguide 2, the contour intervals are narrower in the order of FIGS. 13A, 13B, and 13C. Accordingly, when the first electrode 3 and the second electrode 4 sandwich the optical waveguide 2 obliquely, a stronger electric field is applied to the optical waveguide 2 if the first electrode 3 is stretched upward and the second electrode 4 is stretched sideward as illustrated in FIG. 13C.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An optical modulator comprising:
an optical waveguide made of a material having an electro-optic effect;
a control electrode to control light passing through the optical waveguide; and
a low dielectric constant layer with a dielectric constant lower than a dielectric constant of the optical waveguide; wherein
the control electrode includes a first electrode and a second electrode that generate a potential difference with each other; and
in a cross-sectional view in a direction perpendicular or substantially perpendicular to an extending direction of the optical waveguide:
the first electrode is on first side of the optical waveguide in a width direction and on the first side of the optical waveguide in a thickness direction;
the second electrode is on a second side of the optical waveguide in the width direction and on the second side of the optical waveguide in the thickness direction;
the low dielectric constant layer is interposed between the first electrode and the optical waveguide; and
a portion of the first electrode adjacent to the optical waveguide is in the low dielectric constant layer.

2. The optical modulator according to claim 1, wherein the first electrode includes a corner portion on an optical waveguide side and in the low dielectric constant layer.

3. The optical modulator according to claim 1, wherein
in a cross-sectional view in a direction perpendicular or substantially perpendicular to the extending direction of the optical waveguide:
the optical waveguide includes a first edge extending in the width direction and a second edge parallel or substantially parallel to the first edge and extending in the width direction; and
the first electrode is on a first edge side.

4. The optical modulator according to claim 1, wherein
in a cross-sectional view in a direction perpendicular or substantially perpendicular to the extending direction of the optical waveguide:
the optical waveguide has a semi-elliptical or substantially semi-elliptical shape including a base as a long axis extending in the width direction; and
the first electrode is on a base side.

5. The optical modulator according to claim 1, wherein
in a cross-sectional view in a direction perpendicular or substantially perpendicular to the extending direction of the optical waveguide:
the first electrode has a rectangular or substantially rectangular shape; and
the first electrode is located in a surface of the low dielectric constant layer on a side opposite to the optical waveguide.

6. The optical modulator according to claim 1, wherein
in a cross-sectional view in a direction perpendicular or substantially perpendicular to the extending direction of the optical waveguide:
the first electrode is provided only on the first side of a center of the optical waveguide in the thickness direction; and
the second electrode is provided only on the second side of the center of the optical waveguide in the thickness direction.

7. The optical modulator according to claim 1, further comprising an auxiliary low dielectric constant layer with a dielectric constant lower than a dielectric constant of the optical waveguide between the second electrode and the optical waveguide.

8. The optical modulator according to claim 1, wherein a material of the optical waveguide is LiNbO₃.

9. The optical modulator according to claim 1, wherein one of the first electrode and the second electrode extends from the optical waveguide in the thickness direction and the other of the first electrode and second electrode extends from the optical waveguide in the width direction.

10. The optical modulator according to claim 1, further comprising a substrate including the optical waveguide.

11. The optical modulator according to claim 10, wherein
the substrate is made of a same material as the optical waveguide; and
the optical waveguide is ridge shaped or substantially ridge shaped.

12. The optical modulator according to claim 1, further comprising two optical modulator units each including the optical waveguide, the control electrode, and the low dielectric constant layer, and in parallel or substantially parallel with each other.

13. The optical modulator according to claim 12, wherein the first electrode of a first of the two optical modulator units is integral with the first electrode of a second of the two optical modulator units.

14. The optical modulator according to claim 12, wherein
each of the optical modulator units further includes a substrate including the optical waveguide; and
the substrate of a first of the two optical modulator units is parallel or substantially parallel to the substrate of a second of the two optical modulator units.

15. The optical modulator according to claim 14, wherein
in each of the optical modulator units, the substrate is made of a same material as the optical waveguide; and
the optical waveguide is ridge shaped or substantially ridge shaped.

16. The optical modulator according to claim 14, wherein
the substrate of a first of the two optical modulator units is integrated with the substrate of a second of the two other optical modulator units;
the optical waveguide of the first of the two optical modulator units and the optical waveguide of the second of the two optical modulator units have mutually reversed directions of spontaneous polarization; and
a same phase voltage is mutually applied to the first electrode of the first of the two optical modulator units and the first electrode of the second of the two optical modulator units.

17. The optical modulator according to claim 1, wherein the optical waveguide is located in an upper portion of the substrate.

18. The optical modulator according to claim 1, wherein the optical waveguide is defined by Ti diffused in the substrate.

19. The optical modulator according to claim 1, wherein the optical modulator is a Mach-Zehnder optical modulator.

20. The optical modulator according to claim 12, wherein the optical modulator of each of the two optical modulator units is a Mach-Zehnder optical modulator.
